(19) United States
(12) Patent Application Publication
(10) Pub. No.: US 2002/0156817 A1
(43) Pub. Date: Oct. 24, 2002

(54) System and method for extracting information

(75) Inventor: Gerardo Lemus, London (GB)

Correspondence Address: HALE AND DORR, LLP, 60 STATE STREET, BOSTON, MA, 02109

(73) Assignee: Volantia, Inc.

(21) Appl. No.: 10/080,282

(22) Filed: Feb. 21, 2002

Related U.S. Application Data
(60) Provisional application No. 60/270,747, filed on Feb. 22, 2001.

(51) Int. Cl. G06F 15/00

(52) U.S. Cl. 707/531

(57) ABSTRACT

A system and method for generate structured data from unstructured or semi-structured data uses context-based natural language interpreters. The resulting structured data can be used to create relational database records.

### CROSS-REFERENCE TO RELATED APPLICATION

This application claims priority from provisional serial No. 60/270,747, filed Feb. 22, 2001, which is incorporated herein by reference.

### BACKGROUND OF THE INVENTION

Even before the explosive growth of Internet applications, such as graphic-enabled browsers (such as Mosaic, Netscape, and Internet Explorer), one of the most used applications for electronic information exchange has been “electronic mail” (email). Almost all networks (e.g., Internet, corporate intranets, Bloomberg, and mobile internet), even if not sophisticated enough to handle hypertext, can handle one version or another of email. Regardless of whether the networks and protocols can handle complex graphical user interfaces (GUIs), text is the main information carrying medium.

Information received via email is generally immersed within a certain context. For instance, a subject line might be “RE: meeting on Monday,” which might identify the message as belonging to a “meetings” context. Email formats may allow the embedding of structured data. It is also not uncommon to find an attachment, which might not be text, but some other format, e.g., an Excel spreadsheet. Also, it is well known to provide HTML forms to allow users to enter information field-by-field. However, lack of knowledge, time, or software, causes users to send “semi-structured” data, i.e., data that almost conforms to some predetermined format, by email and through other media. For example, there are standards to send and receive a person's address; e.g., a structured data record for an address may contain five fields: “name”, “apartment”, “street”, “city”, and “postcode”. However, users still send addresses within the textual body of an email, and may abbreviate or omit parts of a complete address.

In systems in which semi-structured data can be sent, such as by email, a structured data record is typically filled manually by data entry personnel when it is received. This is a labor-intensive process, which can also create inaccuracies due to incorrect entry.

### SUMMARY OF THE INVENTION

It would be desirable to overcome the need for manual entry and similar problems by extracting the information automatically and providing it to a searchable database.

The system of the present invention can accept text not in a fully structured form (non-structured data) through one of many media extract information, and store results in a database. The current embodiment describes use of text from emails, although the system could use web pages, a section scanned from a book, pager messages, messages from voice recognition software, and others.

The systems and methods of the present invention can be used to extract information from text, and particularly from unstructured or short semi-structured messages, such as from email, pagers, or other communication devices. The systems and methods are not limited to any particular length of message or means of communication. Furthermore, a voice recognition front end could be used such that information could be provided over a telephone, converted to text or directly to digital data, and then processed according to the present invention.

The system of the present invention allows such text files to be processed and stored in a database, from which searching can be performed on that data using conventional searching techniques.

The system and method of the present invention have a number of aspects, including a system for receiving information in semi-structured or unstructured form from emails, pagers, and other communication methods, and converting that information into a structured form that can be usable in a database. The system and method also include methods for converting semi-structured data or unstructured data into a structured form suitable for use in a database. These methods can include the steps and processes described below or a subset of those steps and processes.

Other features and advantages will become apparent from the description, drawing, and claims.

### BRIEF DESCRIPTION OF THE DRAWING

FIG. 1. is a flow chart of steps of a process according to an embodiment of the present invention.

FIG. 2 is a block diagram of a system according to an embodiment of the present invention.

### DETAILED DESCRIPTION

The system and method of the present invention generate database records from text files containing semi-structured or unstructured data. A database record has a number of fields, where a field is a small fragment of data, together with typing information that specifies what type of information the data represents. For instance, a field might consist of the data 123 456 7890, with the type information being “telephone number.”

Data is defined to be a string of symbols, which may be chosen, for example, from the UNICODE character set. In the preferred embodiment the symbols are strings in the language Perl and are semi-structured, although the present invention could work with unstructured data. The term semi-structured data (SSD) is used in the manner described in the article entitled “Learning Information Extraction Rules for Semi-structured and Free Text,” by Stephen Soderland, Machine Learning, 1-44 (this definition is followed rather than the definition used by the database community, which refers to this as “structured text”). SSD is generally somewhere between data in a rigidly specified grammar (such as XML or HTML) and free text in languages such as English. Typically SSD possesses almost no grammar, and is very telegraphic in style. Examples of SSD may be drawn from classified advertisements in newspapers, such as:

Earl's Court, SW5, the rent is $40 per week.

Other examples include personal ads and home sales. A separate system, such as speech recognition, computer forms, or scanners, is required to extract the text file from the original medium, such as a telephonic conversation, email, or books.

A piece of text could contain one or more pieces of such semi-structured data. For instance, an email could detail, on separate lines, two rental availabilities. Each description of a rental availability would represent one piece of semi-structured data. In the system of the present invention, the two pieces of data would typically be treated separately.

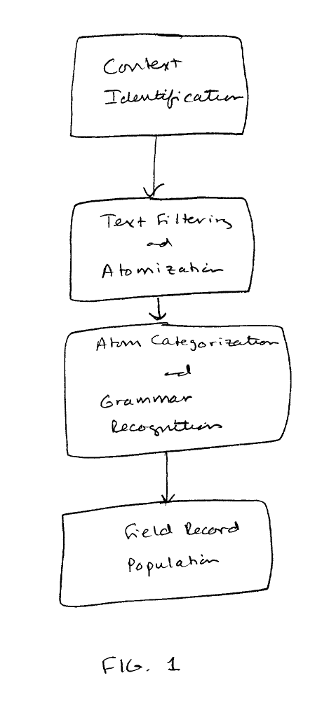

Referring to FIG. 1, an extraction method according to an embodiment of the present invention is divided here conceptually into four sub-processes after documents are obtained and optionally converted:

A: Context identification

B: Text filtering and atomization

C: Atom categorization and grammar recognition

D: Field record population

A: Context Identification

Initially, the text file is context-classified as an information source for one or several data structures. The context is the surrounding information that identifies the characteristics of the information available in the text file.

Context identification classifies the textual data according to a predefined or user-defined context. Context identification might be made using one or more of the following methods:

1. User classification

2. Automatic classification via keyword identification

3. Automatic classification via data-origin or data-destination

4. Automatic classification via pattern identification, such as with machine learning techniques

User classification could include the subject line of an email, such as “rental,” “home sales,” or “personals.” Classification via keyword identification could include looking at the content to identify certain keywords or phrases that would typically be associated with a particular type of context. For data-origin or data-destination identification, the system could look at a particular mailbox in which information is received, or a particular party or one of a group of parties from which information is received. A mailbox for home sales would be classified based on destination, and emails received from repeat customers that are real estate brokers would be classified as home sales as well based on data-origin.

B: Text Pre-Filtering and Atomization

Text pre-filtering attempts to perform data cleaning and massaging. The actual mechanisms used are dependent on the context. Atomization is the process of splitting a given piece of text with white spaces to get a list of the individual words.

The basic steps of this sub-process are:

B1. Atomize

B2. Make Synonymous

B3. Composed Words

In a preferred embodiment, these steps use a method called subReplace, written in Perl:

sub subReplace
{

my ($msg,$REPL_LIST, $ref_flag)=@_;
my ($key, $value);
# Patterns with backreferences:
# If exchange pattern things such as $1 are to interpreted
if ($ref_flag){

while(($key, $value) = each %$REPL_LIST){

eval “\$\$msg =˜ s/$key/$value/g;”;

}

}
# Patterns without backreferences:
else{

while(($key, $value) = each %$REPL_LIST){

$$msg =˜ s/$key/$value/g;

}

}

}

The beginning and end of text may be treated as equivalent to white space. Rather than handling these as separate cases, white space is inserted at the beginning and end of the text.

B1: Atomize.

This step uses a set of pattern matching and replace expressions, which insert white space in correct places, using basic syntactic typing rules. The rules are context dependent, and in the preferred embodiment are stored in a separate database called, for example, “AtomizeRules.” The rules can be programmed in Perl or other language that supports regular expressions and string manipulation. A rule is a regular expression that specifies how white space is to be inserted. For instance, the example might contain a regular expression whose purpose is to insert white space before commas and full stops.

In a preferred embodiment, the database for the “apartment rental” context contains a table with three fields. The first contains a regular expression, the second dictates what any piece of the text that matches that regular expression should be replaced with, and the last is a comment field to aid user comprehension.

An example would be:

Regular expression=‘((?:\s|ˆ )[\[(V{])(?=\S)’

Replace=‘$1’

Comment=‘Left word/phrase delimiters: [{(“‘/, Example ‘(A’->‘(A’

The sentence is then split according to where white space appears into a list of words, or “atoms,” which are what the later stages handle. The atoms are simply strings containing no white space. They can be words or punctuation or combinations thereof depending on the rules.

B2: Make Synonymous.

This step replaces one piece of text with another, where the replacement is considered to be a canonical or correct representation. For instance, common variations in the spelling of a word might be replaced with a canonical word (e.g., Harringay, Harringey, and Haringey might be replaced with the word Haringay). In the preferred embodiment, there is a “Synonymous Words” table in a database that consists of two fields, “change” and “to.” If an atom in the text is found in the “change” field, it is converted into the word found in the “to” field. The change field might be a regular expression, while the “to” field might not be a regular expression.

B3: Composed Words.

In some instances, it is desirable for several words to be treated as a single atom because they represent a single semantic entity. This step handles these cases. A separate database table contains patterns, including white spaces, which are to be replaced with the same words but with the white space replaced with an underscore. In the preferred embodiment, only atoms from the previous stage are used, and are combined into a piece of text again (with only one space between each atom), and apply the expressions found in the database.

The text is split again on white space. Unlike the Atomize stage, spaces are not inserted after the commas in this embodiment.

C: Atom Classification And Grammar Recognition

The atoms are classified into categories using a context specific dictionary by matching words. In this instance, a dictionary represents a list of keys (words or atoms), together with a corresponding value (category). The system loops through the list of atoms, and for each atom checks the dictionary to determine if the text of the atom exists among the keys. If it does exist among the keys, the atom is categorized to the key's value. The algorithm can be extended to have multiple categories per word, and the categorization can be done at the grammar level.

The system further classifies the atoms according to various rules for matching patterns. A RULE_CATEGORIES database manager (DBM) file is used. The system loops through the list of atoms; for each atom, the system checks all keys in the hash as patterns. If the matching is successful, the system categorizes according to the value. This is generally what is done to find numbers, email addresses, or postal codes. Apart from this, this process is similar to the preceding atom classification.

After this categorization has been performed, the system then attempts to apply some basic grammar rules. Unclassified atoms and atom sequences are identified using context-based grammar rules. The grammar function loops through the atom list, checking the individual atoms to determine if they belong to certain categories. Other rules can be added, and the program can iterate until no further grammar rules match.

The extraction method has thus imposed a structure on the document.

D: Field Record Population

The fields of the record corresponding to the context are populated with the classified atoms and/or atom sequences; i.e., a context may include several types of information, such as name, city, and state, and the atoms are classified into those types.

If this stage is not fully completed, e.g., the number of filled fields falls below a predetermined threshold, the output may be deemed invalid. To increase accuracy, the text file may be analyzed using several different contexts, and a scoring method and/or user intervention could be used to identify the correct context and corresponding filled fields.

Once the fields of the record are populated, the system is in a database and can be searched and used in a known and conventional manner. For example, a user could search for an apartment based on a maximum rent, could search for an automobile by make, model, color, etc.; or could search for personals based on self identified types in a known form, such as single white female (SWF).

Physical System

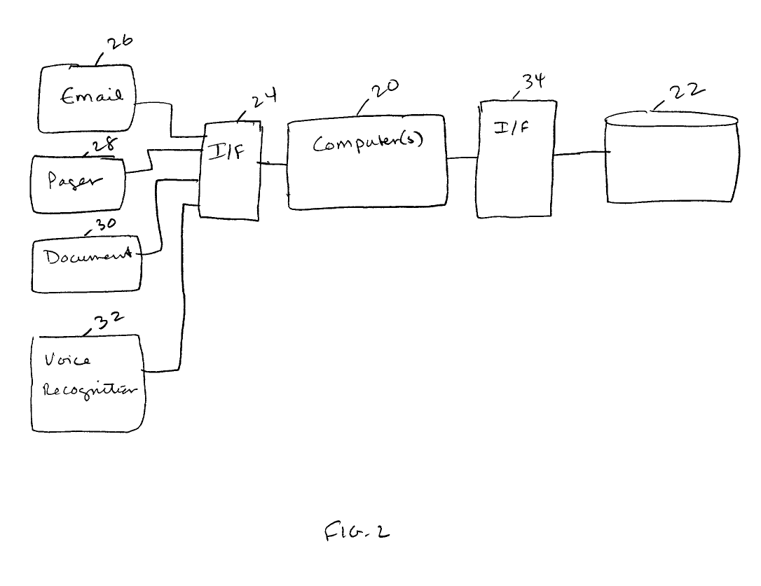

Referring to FIG. 2, the system of the present invention can be implemented on one or more special purpose or general purpose computers 20, appropriately configured and/or programmed, and coupled to a database 22. The system includes an interface 24 to the means from which messages are received, such as over wireless application protocol (WAP), short message service (SMS), email 26, pager 28, document 30, or voice recognition system 32; and an interface 34 to database 22 into which the data is stored in fields. The input can be in text or in a publicly available proprietary form, such as a word processor or PDF document. The data in the database can then be used for searching, report generation, business process management, or other uses.

The computer system that implements the steps and processes described above can be or include application specific integrated circuits (ASICs) or can include one or more personal computers, servers, or other such computational devices or group of devices.

The system can thus receive data from one of a number of different sources and convert that data into structured data for use in a database, such as an Oracle or Sybase database. The resulting data can be used for data mining purposes. As a result, data entry can be fast and intuitive and can be flexible over one of a number of different devices. In addition, there is no need for the user to fill in structured fields and no need to learn complex input formats. As a result, there can be a reduction in data inconsistency and a significant elimination of re-keying, while allowing an entity that uses such a system to access and consolidate data that was previously scattered without impact on existing systems.

The system according to an embodiment of the present invention has software-based extraction engine on the computer with a modular structure optimized for the processing of inputs using pipelines of document stream converters. This pipelining enables the extraction engine to divide up the processing of non-structured information in an efficient manner. The separate concerns of language processing can be addressed by specialized components at every stage of processing while still retaining the efficient management of the overall process of information extraction. For example, there can be multiple context-dependent converters for handling different types of documents after a context has been identified.

The decomposition of linguistic computation enables the system to do an appropriate amount of domain-independent processing, so that domain-dependent semantic and pragmatic processing can be applied to the input, patterns can be matched, and corresponding composite structures built. The composite structures built in each stage provide the input to the next stage.

The earlier stages recognize smaller linguistic objects and work in a largely domain-independent fashion. They use purely linguistic knowledge to recognize that portion of the syntactic structure of the sentence that linguistic methods can determine reliably, requiring little or no modification or augmentation as the system is moved from domain to domain. The later stages take these linguistic objects as input and find domain-dependent patterns among them.

Once streams of documents are being delivered to the extraction engine interface(s) 24, the further processing of the documents is carried out by a chain of different types of document stream converters connected together (many times even a network of them connected together).

The initial processing task may entail the conversion of either a proprietary format document or some other non-text format document to a text document that can be further processed. Examples of converters that may be made available by the extraction engine include MS WORD to text, PDF to text, or HTML to text.

The extraction engine can use one of a number of approaches to prescribe structure. Regular expressions are a simple way to describe structures in a purely declarative fashion. They are fairly easy to learn even for a naive user. To handle more complex examples such as ones that include center embedding, a more sophisticated finitely describable context-free grammar approach can be used.

Allying these methods with intelligence techniques that either learn structure or make it easier to prescribe the structure, the extraction engine facilities the structure buiding stage where the foundations are laid for further information extraction by converting unstructured information into a semi-structured format.

Once a structure-building phase has taken place, there is often further manipulation to take place of the resulting semi-structured information. This further manipulation often falls into two types of processing, either domain-independent or domain-dependent.

Domain-independent processing is generally of a cleaning or filtering nature where a specific part of the semi-structured document is manipulated in a “context-free” manner, such as the removal of leading or trailing white space. The extraction engine accomplishes such manipulation in a straightforward manner.

Domain-dependent processing is the manipulation of parts of the semi-structured document that is dependent on the domain of discourse that the information resides in. For example, semantic information peculiar to the domain of discourse may be used to identify terms and present them in a normalized form. If the domain relates to motorcars, this semantic context may identify terms such as “VW” and “Volksy” and represent them both of them as the normal term “Volkswagen.” The extraction engine provides facilities to accomplish such manipulations. These manipulations consist of term rewrites that utilize lexicons. The triggering of manipulations often relies on the use of the intelligence services described below.

A recording stage includes the final re-structuring of semi-structured documents to structured documents and the subsequent outputting of these structured documents to interfaces to enterprise information systems (EIS), such as databases. This stage involves the extraction of relevant fields from the semi-structured documents; the identification and transformation of fields to types that are suitable for a particular EIS; and the re-mapping of field names that are significant to the enterprise, for example using database schema information when appropriate.

There are numerous applications for such a system. For example, newspapers or other entities that publish classified ads can receive such ads over a number of different media without a structured form and the data can be stored then in a database. This can be used particularly for homes or auto sales, apartment rentals, personals, or other professional services.

The system can be designed to carry out the operations described above and have general applicability for particular applications, additional words and abbreviations can be entered to work with the system, for example, in the real estate context, the system can convert BR to bedroom and fplc to “fireplace.”

The information extraction engine may be made platform independent by using Java technology. The architecture-neutral nature of Java technology is desirable in a networked world where it is difficult to predict what kinds of device customers, partner, suppliers, and employees may use to connect.

### EXAMPLES

### Classified Ads for Rentals

The following example operates on a description of a rental availability. This might have been extracted from an email sent to an online system that provides a catalog of all such availabilities. In an actual test performed with thousands of such ads, the system of the present invention filled data approximately 85% of the time without manual assistance.

This example concerns a (fictitious) entity that publishes a list of rental vacancies, in paper format, once a month. Submissions are accepted for inclusion through mail, email, and by telephone. Reprinting email messages on line would not allow a user to search by location or price. Such functionality involves categorizing the data in some way.

Firstly, assume the content of one email reads as follows:

Earl's Court, SW5, the rent is $40 per week.

A: Context Identification.

In this example, this is not difficult because the subject matter is known to be apartment rentals. It is expected that the subject line would include the words “apartment rentals” or similar, and if it does, the email is processed to extract the textual contents and fed through to the next stage.

B: Text pre-filtering and atomization.

B0. The text has a space inserted at the beginning and end of the phrase.

_Earl's Court, SW5, the rent is $40 per week._{—}

B1. Atomization causes spaces to be inserted before commas and full stops, dollar signs and so on. This is context sensitive in the sense that, if dealing with French, in which prices may be specified as 1.234.567,00 FF, the rules would be different.

Earl's Court, SW5, the rent is $ 40 per week.

B2. Make Synonymous causes equivalent words to be replaced by a canonical word. In this case, all occurrences of $ with the string USD.

Earl's Court, SW5, the rent is USD 40 per week.

B3. Composed Words causes words that the system would like to be considered a single atom to be joined by an underscore. Here, the two words, “Earl's Court”, represent a single semantic entity (a place called Earl's Court). Further, the two words “per week” represent a single semantic entity that relates to a time related quantity. The example becomes:

Earl's_Court, SW5, the rent is USD 40 per_week.

In this case, the system could also have changed “weekly” to “per-week,” and thus “weekly” and “per week” would both be in a “change” column of a table with “per-week” in the “to” column. Earl's Court may be a predefined location, or the system could assume the use of the possessive in the first word links the two words together.

C: Atomization and categorization.

The sentence is broken down into atoms that are then categorized. Atomization proceeds by splitting the sentence on white space, forming a list of atoms or words, which are strings containing no space.

| | | | | | | | | | | |
|---|---|---|---|---|---|---|---|---|---|---|
| Earl's_Court | , | SW5 | , | the | rent | is | USD | 40 | per_week | . |

After this, the atoms are categorized. Initially it is categorized by looking up the atoms in a dictionary. The dictionary simply lists categories for each known atom.

Assume there are the following categories:

“Earl's_Court” as a “tube_station”

“USD” as currency (“ccy”)

“per_week” as cost_time_indicator (“cst_ind”)

“,” and “.” as separators (“sep”)

After categorization, the list of atoms is the same as before, but some of them now have a category:

| | | | | | | | | | | |
|---|---|---|---|---|---|---|---|---|---|---|
| Earl's_Court | , | SW5 | , | the | rent | is | USD | 40 | per_week | . |
| tube_station | sep | | sep | | | | ccy | | cst_ind | sep |

The atoms are further categorized according to patterns. A standard example would be the zip or postal code. Assuming a pattern for finding postal codes (“zip”) and numbers (“nmbr”) has been defined, the atom list now looks like this:

| | | | | | | | | | | |
|---|---|---|---|---|---|---|---|---|---|---|
| Earl's_Court | , | SW5 | , | the | rent | is | USD | 40 | per_week | . |
| tube_station | sep | zip | sep | | | | ccy | nmbr | cst_ind | sep |

The grammar stage is then applied. The grammar stage seeks to further categorize the atoms, but rather than working directly on the atoms themselves, it operates on the categories associated with the atoms.

The notation (ccy) is used to indicate an atom that belongs to the ccy (currency) category. In this context, a (ccy) followed by a (nmbr) could mean the rental cost. The (ccy), followed by (nmbr) and a (cst_ind) might match a grammar expression (cost)=(ccy)(nmbr)(cst_ind). In this example, the system matches on the USD 40 per-week fragment is found.

The rules could insert defaults, such as the currently depending on location, or to insert a cst_ind default, such as monthly, if unstated or if (nmbr) is above and/or below a threshold.

In the preferred embodiment, the system needs to keep a track of this match for the next stage, field record population. The system therefore creates a hash, which is called “cost”. The grammar, having found a match, records in the hash various values against string identifiers. For instance, in this case it would insert “Amount”, “40”into the cost hash, along with “Currency”, “USD”, and “cost_time_indicator”, “per_week”.

D: Field Record Population

In the “apartment rentals” example, there may be interest in fields such as “house number”, “post code”, “currency” (USD), “cost” (40), “period” (per week) and so on. In the preferred embodiment the fields are specified using the following Perl function:

sub get_Fields {

my %fields =(

| “email_address” => “”, | | |
|---|---|---|
| “tube_station” => “”, | | |
| “uk_zip_code” => “”, | | |
| “tel_number” => “”, | | |
| “rooms” | => | {“number_rooms” => “1”, |
| | | “room_type” => “”}, |
| “cost” | => | {“Amount” => “”, |
| | | “Currency” => ”, |
| | | “cost_time_indicator” => ”}, |

“shared_in” => “”,
“original_message” => “”,
“no_smoking” => “”,
);

return\%fields;

}

If a field, such as “email_address,” has nothing following the =>sign, then it is considered simple, and the algorithm fills the field with any atoms that have been matched to the corresponding “email_address” category (if any). Otherwise, the algorithm will look at the hash created during the grammar step, and attempt to extract values the relevant values. In the previous stage, the grammar inserted the values “Amount”, “40”into the cost hash. At this point, information is extracted and provided to the relevant field.

What happens after this stage is application dependent. In this example, the extracted fields would be used to fill fields in a searchable database. The database can be accessed, e.g., over the Internet, to look for one or more matching words, or for numbers greater or less than a given number. Thus, a later user searching for apartments near Earl's Court, or weekly rental of $50 per week or less would find the exemplary listing set out above. The system could also extract “A/C” or “AC” or “air” for air conditioning, and other features.

### Financial

At an investment bank, the equity capital markets (ECM) gathers pre-marketing data from prospective investors about new stock issues. This feedback either comes in the form of a freeform email or a Word attachment. This Word document is a questionnaire and is generally filled out in detail. Alternatively, the emails tend to be concise opinions written in free form text.

The staff at the ECM desk could manually remove relevant data from each message and aggregate this information into a report that summarizes the emails. With a system such as that described above, the email information is extracted and provided into a structured database. The system categorizes emails as positive or negative and generates a report.

### Articles

The system can extract information form financial articles with different contexts. For example, profit warnings may be one context, while mergers and acquisitions is another. A database can then be built of transactions and of warnings.

Having described embodiments, it should be apparent that modifications can be made without departing from the scope of the invention as defined by the appended claims.

What is claimed is:

1. A method comprising:
receiving non-structured documents from one or more of a number of sources;
in an automated manner, using rules to extract words and categorized from the document;
storing the words into a database based on the categorization for subsequent retrieval.

2. The method of claim 1, wherein the sources include fax, e-mail, and/or pager data.

3. The method of claim 2, wherein the non-structured documents are received from email.

4. The method of claim 3, wherein the non-structured documents include classified ads, the method converting the emails from a series of ads into a searchable database for subsequent queries.

5. The method of claim 4, wherein the classified ads include ads for one or more of homes, apartments, personals, and automobiles.

6. The method of claim 1, wherein the process of using rules to identify and extract words from the document includes identifying a context and using rules tailored to that context.

7. The method of claim 6, wherein the documents include emails and the identifying includes identifying the emails as classified ads.

8. The method of claim 7, wherein identifying the context includes identifying the context based on an identification from the sender of the email.

9. The method of claim 7, wherein identifying the context includes identifying the context based on a source of the email.

10. The method of claim 7, wherein identifying the context includes identifying the context based on a destination of the email.

11. The method of claim 7, wherein identifying the context includes identifying the context based on keywords in the email.

12. The method of claim 6, wherein the process of using rules to identify and extract words from the document further includes: (a) atomizing the document to create strings, (b) comparing words in the atomized document to a table for the purpose of replacing words with substitutes if the words are found in the table, (c) after (b), classifying the atoms according to a set of rules, and (d) populating the database with the classified atoms.

13. The method of claim 12, wherein the atoms include words and punctuation as separate atoms.

14. The method of claim 12, further comprising combining multiple words into individual atoms based on a set of rules.

15. The method of claim 1, further comprising, prior to the using rules process, converting the documents from a proprietary format into a text format.

16. The method of claim 15, wherein the proprietary method includes a word processing document or a display format.

17. The method of claim 1, wherein the non-structured documents are articles.

18. The method of claim 1, wherein the non-structured documents are news reports.

19. The method of claim 1, wherein the non-structured documents are customer feedback.

20. The method of claim 1, wherein the receiving includes receiving from a voice recognition system that converts spoken words into a document.

21. An information extraction system comprising:
an information extraction engine for receiving a non-structured document and, in and automated manner, extracting and classifying words; and
a database for storing the extracted words in accordance with the classification for subsequent searching.

22. The system of claim 21, further comprising an interface for converting a received document in a proprietary format to a text document and for providing it to the extraction engine.

23. The system of claim 22, further comprising multiple interfaces for converting multiple types of documents in different formats.

24. The system of claim 21, wherein the non-structured document is an email document.

25. The system of claim 24, wherein the database stores information from classified ads for later searching.
